(19) United States
(12) Patent Application Publication
(10) Pub. No.: US 2003/0214885 A1
(43) Pub. Date: Nov. 20, 2003

(54) Electronic time-telling device

(76) Inventors: Summer Powell, New York City, NY (US); Liisa Salonen, Windsor (CA); Melissa Paul, Key West, FL (US)

Correspondence Address: MANELLI DENISON & SELTER PLLC, 7th Floor, 2000 M Street, N.W., Washington, DC, 20036-3307, US

(21) Appl. No.: 10/146,802

(22) Filed: May 17, 2002

(51) Int. Cl. G04C 17/00; G04B 19/00; G04B 25/00

(52) U.S. Cl. 368/223

(57) ABSTRACT

The present invention provides a wearable electronic device with a miniature, flat, high-resolution, full color screen for a face, designed to display time and provide entertainment through the use of motion graphics. Animations on the miniature screen display time through alphanumeric sequences, “hands” or through other graphic structures. The timepiece may display time on the miniature screen in typical digital-or analog-style formats, in a moiré format, or other graphic formats where the graphic and/or video forms are an integral part of the time-telling display, and replace or augment the use of either hands or numbers. The timepiece may be worn on the person as a wristwatch, a pendant, an armband, a pin, or other wearable item.

### BACKGROUND OF THE INVENTION

1. Field of the Invention

The present invention relates to watches. More particularly, it relates to a wearable electronic time-telling device including an LCD.

2. Background of Related Art

Digital advances have led to the development of many kinds of multi-functioning devices, e.g., the video game watch, and the calculator watch. Besides telling time, they provided extra functionality and/or entertainment. Recent technological advancement has led to the development of hybrid devices such as the VisorPhone by MOTOROLA and HANDSPRING, the Wrist Audio Player by CASIO, and an IBM Linux Watch with Bluetooth™ capabilities. Many types of multi-functioning watches are now available including watches with beepers, watches with alarms, watches with messaging components, watches containing cameras or video-cameras, watches containing personal digital assistants, and so forth. Watches with monochromatic, low-resolution animation are also available including the CASIO Film Watch for the Japanese market, and the Britney Spears watch by TRENDMASTERS.

These developments have all contributed to the use of wearable technology, of technology as jewelry, or technology as wearable entertainment.

Previous digital timepieces have utilized small, low-resolution, black and white LCD screens to display the alphanumeric time. Some digital watches have utilized low-resolution LCD screens to show animating images that both display the time and entertain the user.

Digital timepieces have previously displayed the time in digital-style format using alphanumeric characters formed by means of pixels to display the time and other information. Previous inventions have also used mock analog-style format “hands” formed by means of pixels to display the time, or a combination of both digital- and analog-style. Other conventional designs included low-resolution animations of abstract graphics and patterns for the purpose of entertainment. These animated graphics are sometimes used as interstitials between functions such as the transition between seeing the time and seeing the date.

### SUMMARY OF THE INVENTION

In accordance with the principles of the present invention, a time telling device comprises a color display, a first image comprising at least a first color adapted for display on the color display, and a second image comprising at least a second color adapted for display on the color display. The way that the first image overtakes the second image tells a time of day.

A method of telling time on a color display in accordance with another aspect of the present invention comprises creating for display on a color display a first graphic image, and creating for display on the color display a second graphic image. Visual motion is created between the first graphic image and the second graphic image by moving both the first graphic image and the second graphic image in relation to one another so that the first graphic image overlaps and eventually overtakes the second graphic image, an amount of overtaking telling a time of day.

### BRIEF DESCRIPTION OF THE DRAWINGS

Features and advantages of the present invention will become apparent to those skilled in the art from the following description with reference to the drawings, in which:

FIG. 1 shows a block diagram of relevant portions of an exemplary electronic time telling device, in accordance with the principles of the present invention.

FIG. 2 shows an exemplary process of telling time with overtaking color images, in accordance with the principles of the present invention.

FIGS. 3A to 3G: Large numerals are made up of multiple dots and small numerals are superimposed on a video sequence of a subway train to create the time-telling function. The dots making up the large numerals are also sequentially animated. The video footage, together with the dots, gives the appearance of a miniature fast-paced movie.

FIGS. 4A to 4C: Numerals telling the time are superimposed on a video sequence of a flame. The numerals fade in and out to coincide with the motion of the flame. Another type of graphic animation in this example is utilized to create a digital moiré effect.

FIGS. 5A to 5G: Two rotating photographic images are utilized, and the moiré effect is created through the overlapping and animation of the minute “hand” and the second “hand”, and by the difference in speed at which they rotate. Unconventional graphic forms are utilized for “hands”: a blue dot is the hour hand, a large a half-moon shape is the minute hand, and a large abstracted leaf shape is the second hand.

FIGS. 6A to 6G: This structural moiré forms watch hands as an integral component of the time-telling function. It utilizes a digital moiré effect, and the hour and minute hands are formed by the difference in color of the two moirés. The difference in speed at which the hour and minute hands rotate around the face creates both the moiré and the watch “hands.”

FIGS. 7A to 7D: Alphanumeric characters are superimposed on a digital moiré to tell the time. In this Fig., the fast-moving moiré is generated along vertical and horizontal axes, and emanates from these axes which are at the center of the face.

FIGS. 8A to 8G: A slowly changing pattern/composition is formed by “hands” made of stripes which overlap. In this version, unconventional graphic forms represent the analog version of watch hands. The red line is the hour hand and the white line is the minute hand. The moiré is generated by the overlapping of the hands, and the difference in speed at which the hour “hand” and the minute “hand” rotates around the face.

### DETAILED DESCRIPTION OF ILLUSTRATIVE EMBODIMENTS

The present invention utilizes motion technologies to create motion sequences allowing novel ways of displaying time.

The disclosed timepieces combine miniature, flat, high-resolution, full-color screens; a miniature high-capacity processor (e.g., a microcontroller, microprocessor and/or digital signal processor (DSP)), high-capacity memory, to produce a unique way of telling time and/or providing entertainment.

The present invention utilizes a miniature, flat, high-resolution full-color screen (e.g., liquid crystal diode (LCD)) to display the time of day and simultaneously entertain the user through the use of high-resolution motion graphics. The motion graphics preferably operate to display the time itself.

The disclosed embodiments relate to time-telling devices that are worn on the person, though aspects of the present invention relate equally to other types of timepieces. The disclosed wearable digital timepieces have an electronic full-color display for the time-telling component, also known as the face of the timepiece. The electronic display is designed for the purpose of displaying data as sequentially animated time and/or entertainment and/or art.

Motion sequences in accordance with the principles of the present invention may be captured, edited, and exported, e.g., through the use of commercially available programs like Adobe Premiere, Adobe After Effects and Macromedia Flash, among others. The motion, image and video sequences may be in vector and/or pixel formats.

For the purpose of this description, the word “screen” is used to describe the electronic display screen or face of the time telling device. This screen is a miniature, flat, high-resolution, full color screen utilizing LCD, field emission display or other technology.

For the purpose of this description, the word “hand” is used to describe any or all of the following: 1. a digital version of traditional clock hands where the short hand represents the hour and the long hand represents the minutes; 2. a line which is formed at the intersection of two different colors and rotates around the face and functions as a hand; 3. a shape which is different from the traditional hand and which rotates around the face and functions as a hand; 4. a dot which rotates around the face to indicate the hour and functions as a hand.

One innovation of the present invention is the display of time using motion graphics in an analog- and/or digital-style manner within a miniature, flat, high-resolution, full color screen, also known as the face of the watch.

Another innovation of the present invention is the incorporation of high-resolution video sequences into the time-telling function. Earlier instances of sequential animation on watches could not do this because many aspects of the necessary technologies were not advanced enough to handle the larger amounts of data necessary to incorporate high-resolution video sequences into the time-telling function. Software did not allow for the compression of data into smaller amounts, and the low-resolution and slow refresh rate of LCD screens made video sequences difficult to present. Earlier animations have used large monochromatic “pixels” to simulate video animation, yet have not displayed high-resolution full color motion, as does the present invention.

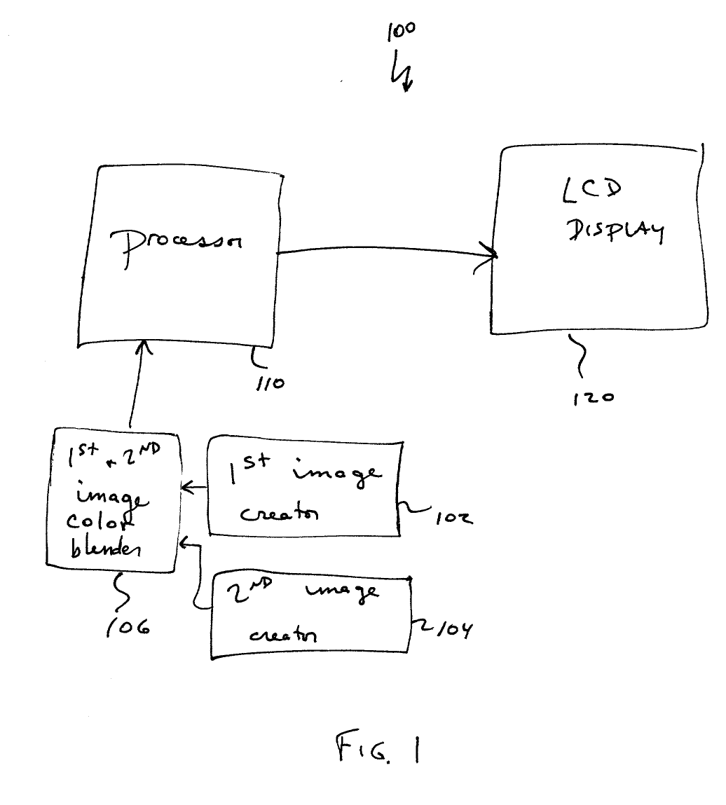

FIG. 1 shows a block diagram of relevant portions of an exemplary electronic time telling device, in accordance with the principles of the present invention.

In particular, as shown in FIG. 1, an electronic time telling device 100 includes a processor 110, e.g., microprocessor, microcontroller, or digital signal processor (DSP). A first image creator 102, a second image creator 104, and a first and second image color blender 106 create an image for display on a color display 120 (e.g., an LCD color, active or inactive display). The image creators 102, 104 and color image blender 106 are preferably portions of software code resident in a suitable memory accessible as program ROM to said processor 110.

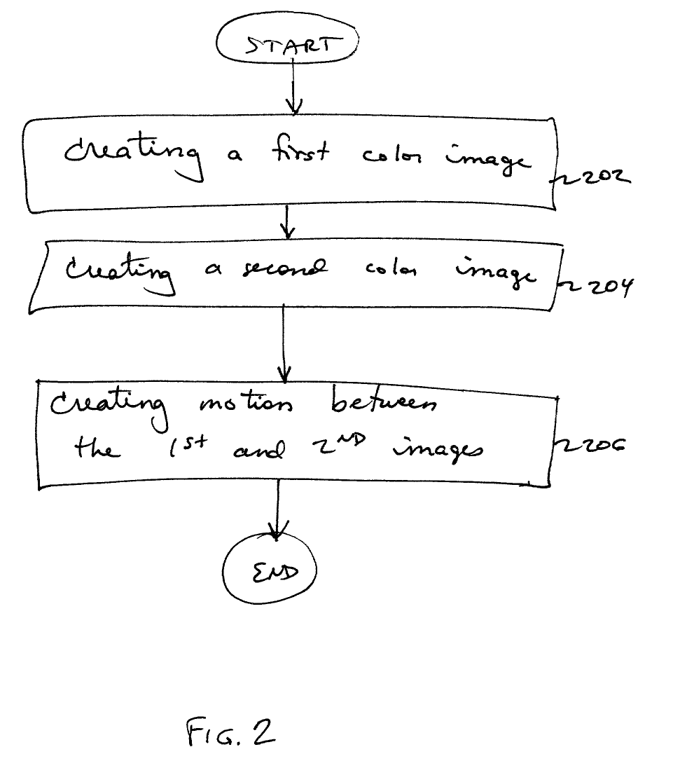

FIG. 2 shows an exemplary process of telling time with overtaking color images, in accordance with the principles of the present invention.

In particular, as shown in step 202 of FIG. 2, a first color image is created.

In step 204, a second color image is created.

In step 206, motion is created between the first image and the second image, with the relative position of the two image with respect to one another displaying a time of day.

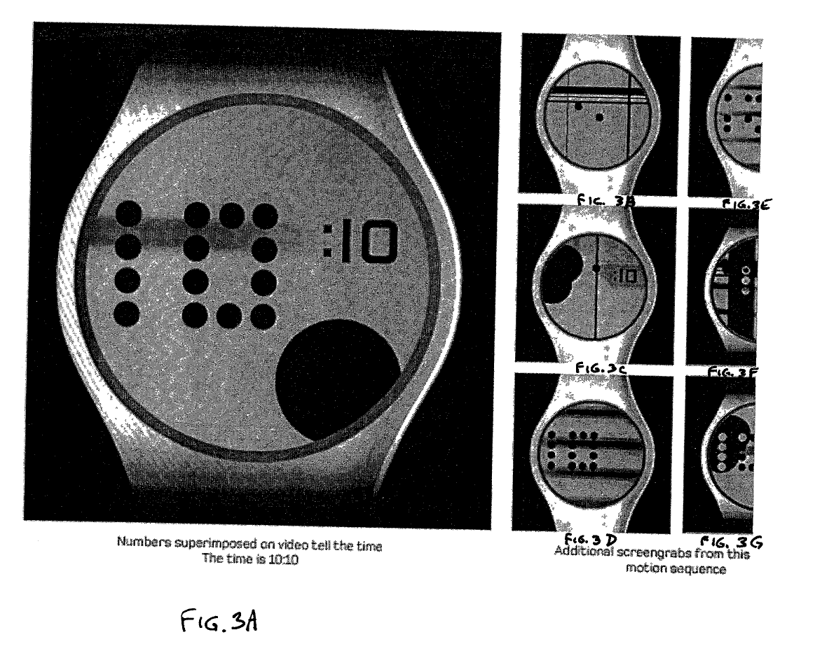

FIGS. 3A to 3G shows large numerals made up of multiple dots and small numerals are superimposed on a video sequence of a subway train to create the time-telling function. The dots making up the large numerals are also sequentially animated. The video footage, together with the dots, gives the appearance of a miniature fast-paced movie.

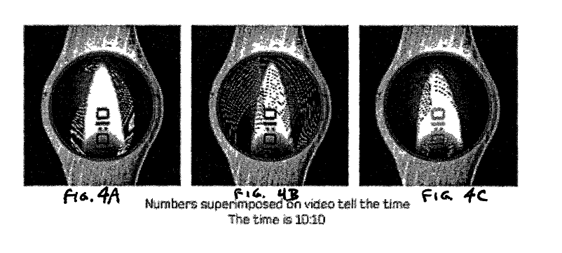

In FIGS. 4A to 4C, numerals telling the time are superimposed on a video sequence of a flame. The numerals fade in and out to coincide with the motion of the flame. Another type of graphic animation in this example is utilized to create a digital moiré.

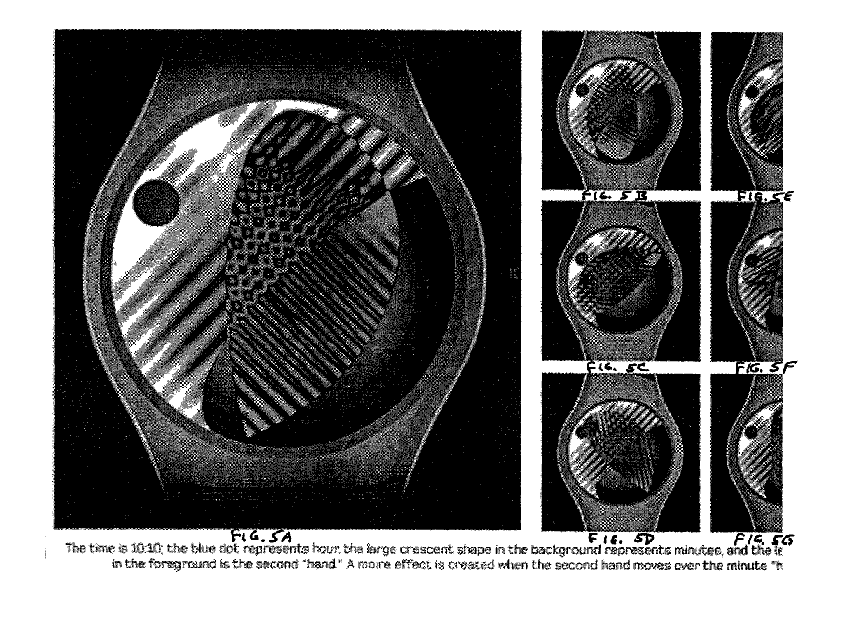

FIGS. 5A to 5G incorporates two rotating photographic images, and a moiré effect is created through the overlapping and animated movement of the two images.

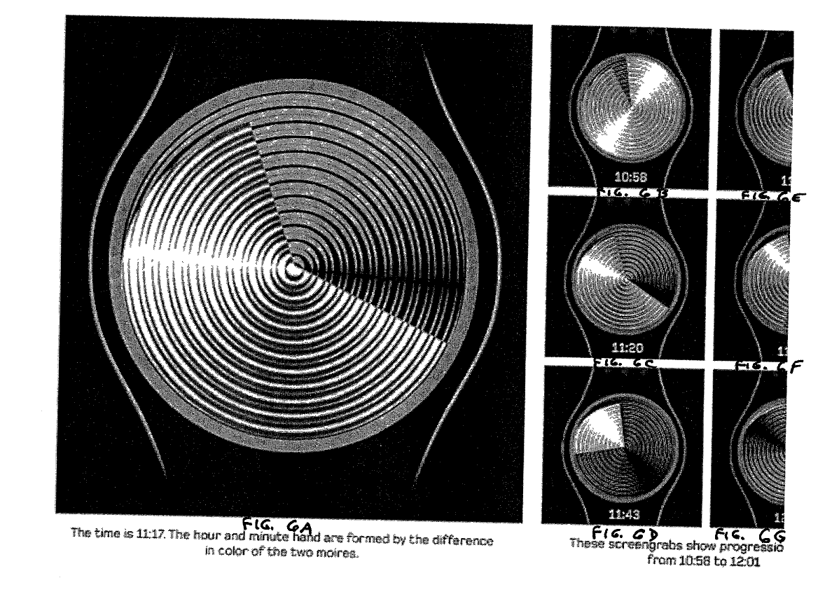

Another innovation of the present invention is the utilization of a digital moiré effect which forms watch hands as an integral component of the time-telling function, as shown in FIGS. 6A to 6G. This structural moiré displays time as a cycle, and is created through the use of full-screen motion graphics. Two moiré patterns of different colors (blue and brown) are layered upon each other, and the watch hands are created by the difference in color of the two moirés. Each cycle is an hour, and in each hour the implied minute hand (the longer hand) overtakes the implied hour hand (the shorter hand), thereby changing the dominant color of the watch. In the example (FIGS. 6A to 6G), the dominant face color alternates each hour between blue and brown. As the hand rotates around the face in the first hour, the first color (blue) is replaced by the second color (brown). As the hand rotates around the face in the next hour, the second color (brown) is replaced by the first color (blue), and so forth. Although moir's were used in fashionable analog watches during the mid-1900s, they have not been possible to achieve in digital watches with low-resolution LCD faces. Timepieces have not utilized digital moirés to tell time in the past.

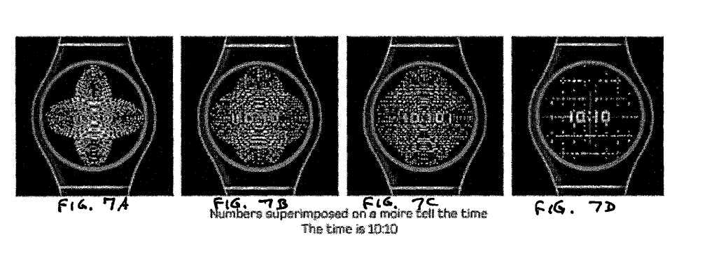

FIGS. 7A to 7D incorporates alphanumeric characters superimposed on another type of digital moiré. In this FIGS. 7A to 7D, the fast-moving moiré is generated along vertical and horizontal axes, and emanates from these axes which are at the center of the face.

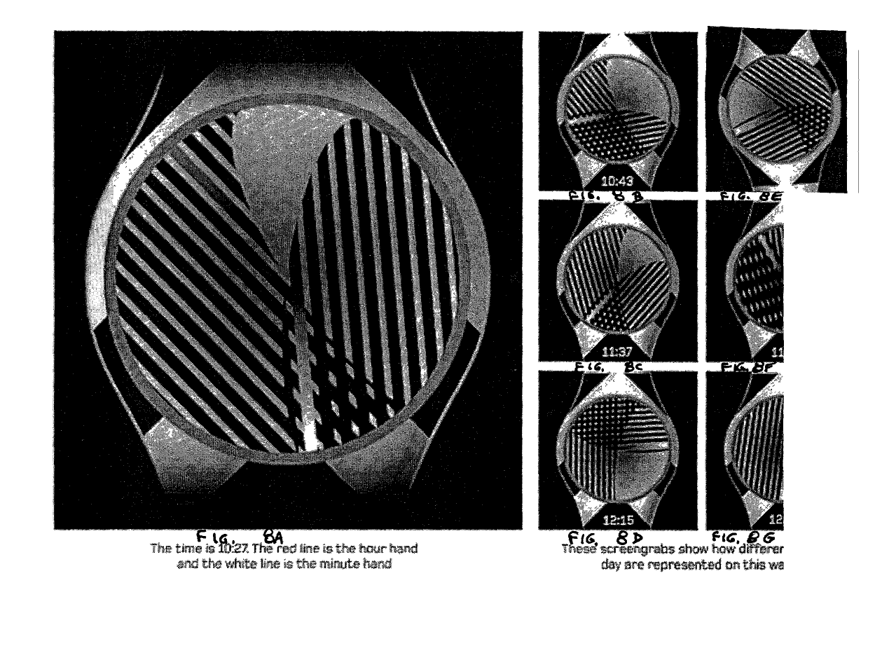

FIGS. 8A to 8G features a slowly changing pattern/composition formed by “hands” made of stripes which overlap. In this Fig., the moiré is generated by the overlapping of the hands, and the difference in speed at which the hour “hand” and the minute “hand” rotate around the face.

In FIGS. 5A to 5G, the moiré is again created by overlapping two distinctly different “hand” shapes, and by the difference in speed at which the hour “hand” and the minute “hand” rotate.

Another innovation of the present invention is the use of unconventional graphic forms to represent the analog version of watch hands on a miniature, flat, high-resolution, full color screen. Figs. C and F illustrate this innovation. In FIGS. 5A to 5G, the design utilizes a blue dot as the hour hand, a large half-moon shape as the minute hand, and a large abstracted leaf shape as the second hand. The previously mentioned digital moiré effect (illustrated in Figs. B, C D and E) is also utilized in this design.

Another innovation of the present invention is the use of unconventional graphic forms to represent numbers as in the above-mentioned dots of FIGS. 3A to 3G, on a miniature, flat, high-resolution, full color screen. In this example numbers are made up of multiple dots which are sequentially animated to display the form of the numeral, creating numerals that are sometimes fully legible and at other times appear as a pattern.

These innovations have potential application in a wide variety of other hybrid and/or multi-functioning devices. In addition to displaying time and/or entertainment, these time-telling devices have vast potential in developing as fashion, as art, and as a variety of marketing, advertising, and licensed products. Possible applications for this enhanced time-telling device include date, stop watch, calculator, memory/phone number recall, email/instant messaging, health monitor, safety/security device, and so forth. Applications relating directly to this innovation could also be graphic interfaces for a multi-functioning personal device, such as a phone, personal digital assistant, MP3 or other audio player, or hybrids of the above to create a genre of super watch or super device. Interstitials between time telling and the above-mentioned functions could utilize the type of graphic language in the examples shown.

Other potential developments of the present innovation include downloading product updates and downloading/buying new digital products or programs for the device from the Internet. Downloadable options could include new time-telling functions/graphics, and new functions in general, such as games, calculators, music/songs/audio, alarm clock, personal organizer, map, foreign dictionary, currency translator, and so forth. Transfer of these digital products and updates may be possible through the use of wireless, infrared, Airport, Bluetooth™ or other transfer technologies, or may be purchased as interchangeable, removable media such as a disk or other item.

Another potential development of the present innovation is operating the device in different modes. Besides time-telling mode, optional modes could include message/email mode, screensaver mode, game mode, alarm clock mode, dictionary mode, your own graphics programming mode, and so on. The user might toggle between modes using a button, or buttons, or might use a touch display.

Another potential development is utilization of touch-screen technology to accomplish any of the above functions in conjunction with graphics.

Another innovation is the potential for the miniature, flat, high-resolution, full color screen face to incorporate different face shapes in addition to traditional rectilinear or circular shapes.

Another innovation is the potential utilization of flexible sheets of LCD or other screen material as the watch/device. This material could wrap around the wrist as a bracelet, around the waist as a belt, or be constructed into a garment such as a shirt or jacket. The entire surface of such items could then animate to tell the time, entertain, etc.

Thus, a wearable electronic device is provided with a miniature, high-resolution, full color screen for a face, and is designed to simultaneously display time and provide entertainment through the use of motion graphics. The digital timepiece stores digital data on the internal microprocessor. The digital data is visually presented on the entire or part of the entire digital display face as small scale, high-resolution, full color motion graphics for the purposes of telling time and/or entertainment.

The digital data is visually presented as motion graphics which integrate digital video sequences, sequential graphic animation in pixel and/or vector formats, and animated sequences that display time alphanumerically, through representation of mock analog-style watch hands, or through other graphic forms. The timepiece may display time on the miniature screen in typical digital- or analog-style formats, in a moiré format, or other graphic formats where the graphic forms are an integral part of the time-telling display and replace the use of either hands or alphanumeric characters. The timepieces display time in the form of hours and minutes, and may or may not display seconds. The timepieces may also display the date, the temperature, the location, or other information.

The timepiece is designed to be worn on the person as a wristwatch, a pendant, an armband, a pin, a belt, a bracelet, or other wearable item.

The timepiece may utilize the integration of a miniature, high-resolution, active matrix liquid crystal display with on-chip driver and decoding circuitry which use liquid crystal semiconductor technology. This technology is available in the United States through the MicroDisplay Corporation. The technology displays full-color digital video on the miniature display screens. The screens can be either luminous or flat reflective surfaces, and when used with LED the resolution is enhanced, and the graphics are more luminous. The timepiece may be powered by an internal smart digital memory card developed by Matsushita Electric Industrial Company of Japan, or by the memory stick technology produced by SONY of Japan.

The timepiece may be programmed specifically with the functional requirements of a time-telling device. It could also be programmed utilizing a database of information where the graphic components that create the time display (hands) are generated through information accessed from the database.

While the invention has been described with reference to the exemplary preferred embodiments thereof, those skilled in the art will be able to make various modifications to the described embodiments of the invention without departing from the true spirit and scope of the invention.

What is claimed is:

1. A time telling device, comprising:
a display;
a first image adapted for display on said display; and
a second image adapted for display on said display;
wherein a way said first image overlaps and overtakes said second image tells a time of day.

2. The time telling device according to claim 1, wherein:
said display is a color display.

3. The time telling device according to claim 2, wherein:
said first image comprises a first color;
said second image comprises a second color different from said first color; and
said first color of said first image and said second color of said second image are color-blended in overlapped areas on said color display while in motion.

4. The time telling device according to claim 1, wherein:
said time telling device is mounted on a wristwatch.

5. The time telling device according to claim 1, wherein:
neither said first image nor said second image are traditional clock face images.

6. The time telling device according to claim 2, wherein:
said color display is a liquid crystal display.

7. The time telling device according to claim 6, wherein:
said color display is back-lit.

8. The time telling device according to claim 2, wherein:
said color display is an active liquid crystal display.

9. A method of telling time on a color display, comprising:
creating for display on a display a first graphic image;
creating for display on said display a second graphic image; and
creating visual motion between said first graphic image and said second graphic image by moving both said first graphic image and said second graphic image in relation to one another so that said first graphic image overlaps and eventually overtakes said second graphic image, an amount of overtaking telling a time of day.

10. The method of telling time on a color display according to claim 9, wherein:
a color of said first image is blended with a color of said second image in said overlapped portion.

11. The method of telling time on a color display according to claim 10, wherein:
said first graphic image comprises at least a first color;
said second graphic image comprises at least a second color different from said first color; and
a color of said overlapped portion results from said first color mixed with said second color.

12. Apparatus for telling time on a color display, comprising:
means for creating for display on a display a first graphic image;
means for creating for display on said display a second graphic image; and
means for creating visual motion between said first graphic image and said second graphic image by moving both said first graphic image and said second graphic image in relation to one another so that said first graphic image overlaps and eventually overtakes said second graphic image, an amount of overtaking telling a time of day.

13. The apparatus for telling time on a color display according to claim 12, wherein:
said means for creating visual motion blends a color of said first image with a color of said second image in said overlapped portion.

14. The apparatus for telling time on a color display according to claim 12, wherein:
said first graphic image comprises at least a first color;
said second graphic image comprises at least a second color different from said first color; and
a color of said overlapped portion results from said first color mixed with said second color.
